(19) United States
(12) Patent Application Publication
(10) Pub. No.: US 2012/0107148 A1
(43) Pub. Date: May 3, 2012

(54) Hermetic compressor

(75) Inventor: Seo Hee Lee, Gwangju (KR)

(73) Assignee: SAMSUNG ELECTRONICS CO., LTD., Suwon-si (KR)

(21) Appl. No.: 13/317,358

(22) Filed: Oct. 17, 2011

(30) Foreign Application Priority Data
Oct. 27, 2010 (KR) 10-2010-0105381

(51) Int. Cl. F16C 7/02; F04B 17/00

(52) U.S. Cl. 417/321; 74/579 R

(57) ABSTRACT

A hermetic compressor includes a drive unit to provide drive power for compression of a refrigerant, a shaft having a body portion coupled to the drive unit and an eccentric shaft portion provided at one end of the body portion to perform eccentric rotational motion, and a piston connected to the eccentric shaft portion via a connecting rod to perform rectilinear reciprocating motion. The connecting rod includes a shaft coupling portion provided at one end thereof for coupling with the shaft, the shaft coupling portion having a coupling hole into which the eccentric shaft portion is rotatably inserted, and a piston coupling portion provided at the other end thereof so as to be rotatably coupled into the piston. The coupling hole has an increasing diameter toward the body portion to ensure that the refrigerant is efficiently compressed even if the shaft is inclined.

### CROSS-REFERENCE TO RELATED APPLICATIONS

This application claims the benefit of Korean Patent Application No. 2010-0105381, filed on Oct. 27, 2010 in the Korean Intellectual Property Office, the disclosure of which is incorporated herein by reference.

### BACKGROUND

1. Field

Embodiments of the present disclosure relate to a hermetic compressor to effectively compress a refrigerant even if a shaft is inclined.

2. Description of the Related Art

Generally, a hermetic compressor is a device used in a refrigeration cycle of a refrigerator or an air conditioner to compress a refrigerant.

A conventional hermetic compressor includes a hermetic container defining an outer appearance of the compressor, in which a compression unit to compress a refrigerant and a drive unit to provide compression drive power are accommodated. The drive unit may be a motor consisting of a stator and a rotor. The compression unit is installed using a frame within the hermetic container.

FIG. 1 is a partial view of a conventional hermetic compressor with regard to a compression unit.

As illustrated in FIG. 1, the compression unit may include a cylinder 1, which defines a compression chamber and is integrally formed with a frame 2, and a piston 3 adapted to be rectilinearly reciprocated in the compression chamber.

A shaft 4 is press-fitted into a rotor (not shown) of a drive unit (not shown) so as to be rotated along with the rotor (not shown). The shaft 4 press-fitted into the rotor (not shown) rotatably penetrates a center through-hole (not shown) of the frame 2, at one side of which the cylinder 1 is secured.

A connecting rod 5 is provided between the shaft 4 and the piston 3 to convert rotational motion of the shaft 4 into rectilinear reciprocating motion of the piston 3.

The shaft 4 includes a body portion 4a press-fitted into the rotor (not shown), and an eccentric shaft portion 4b provided at one end of the body portion 4a and adapted to eccentrically rotate during rotation of the shaft 4.

The connecting rod 5 includes a shaft coupling portion 6 at one end thereof, which is rotatably coupled to the eccentric shaft portion 4b, a piston coupling portion 7 at the other end thereof, which is rotatably coupled to the piston 3, and a connecting portion 8 between the shaft coupling portion 6 and the piston coupling portion 7. The shaft coupling portion 6 has a coupling hole 6a into which the eccentric shaft portion 4b is rotatably inserted. That is, the shaft coupling portion 6 is rotatably coupled to the eccentric shaft portion 4b via the coupling hole 6a. As such, the connecting rod 5 connects one end of the shaft 4 and the piston 3 located close to the end of the shaft 4 to each other. The coupling hole 6a longitudinally has a constant diameter and a sliding tolerance exists between the diameter of the coupling hole 6a and an outer diameter of the eccentric shaft portion 4b.

In operation, if the shaft 4 is rotated along with the rotor (not shown) by the drive unit (not shown), the eccentric shaft portion 4b at one end of the shaft 4 eccentrically rotates, causing the piston 3 connected to the eccentric shaft portion 4b via the connecting rod 5 to be rectilinearly reciprocated within the compression chamber. Thereby, a refrigerant is compressed within the compression chamber.

It is noted that the shaft 4 is not completely rigid although it is made of a rigid metallic material. Therefore, for the lifespan of the hermetic compressor, the shaft 4 may be inclined by force applied from the piston 3 during compression of the refrigerant. In this case, the eccentric shaft portion 4b connected to the connecting rod 5 is inclined in an opposite direction of the piston 3.

If the eccentric shaft portion 4b is inclined in an opposite direction of the piston 3, as illustrated in FIG. 1, a potential contact region between the eccentric shaft portion 4b and the coupling hole 6a is limited to a lower region of the coupling hole 6a in the drawing. Thus, friction between the eccentric shaft portion 4b and the coupling hole 6a causes concentrated abrasion of the shaft coupling portion 6 at the lower region of the coupling hole 6a, which may cause deformation of the connecting rod 5, making normal compression of the refrigerant impossible.

In addition, as described above, since the cylinder 1 is integrally formed with the frame 2 so as not to be separated from the frame 2 and a sliding tolerance exists between the diameter of the coupling hole 6a and the outer diameter of the eccentric shaft portion 4b, assembling the connecting rod 5 and the eccentric shaft portion 4b of the conventional hermetic compressor may be difficult.

In other words, to assemble the connecting rod 5 with the eccentric shaft portion 4b, conventionally, the piston coupling portion 7 of the connecting rod 5 is first rotatably inserted into the piston 3 and then, the piston 3 is inserted into the compression chamber. Thereafter, the shaft coupling portion 6 of the connecting rod 5 is fitted on the eccentric shaft portion 4b from the top of the eccentric shaft portion 4b. Due to a sliding tolerance between the diameter of the coupling hole 6a and the outer diameter of the eccentric shaft portion 4b as described above, the conventional hermetic compressor has an extremely narrow gap between the coupling hole 6a and the eccentric shaft portion 4b, which makes inserting the eccentric shaft portion 4b into the coupling hole 6a difficult.

### SUMMARY

It is one aspect of the present disclosure to provide a hermetic compressor to effectively compress a refrigerant even if a shaft is inclined.

It is another aspect of the present disclosure to provide a hermetic compressor in which a connecting rod has an improved configuration to ensure easier assembly between a coupling hole of the connecting rod and an eccentric shaft portion of a shaft.

Additional aspects of the disclosure will be set forth in part in the description which follows and, in part, will be apparent from the description, or may be learned by practice of the disclosure.

In accordance with one aspect of the disclosure, a hermetic compressor includes a drive unit to provide drive power for compression of a refrigerant, a shaft having a body portion coupled to the drive unit so as to be rotated by the drive unit and an eccentric shaft portion provided at one end of the body portion to perform eccentric rotational motion, and a piston connected to the eccentric shaft portion via a connecting rod to perform rectilinear reciprocating motion within a compression chamber, wherein the connecting rod includes a shaft coupling portion provided at one end thereof for coupling with the shaft, the shaft coupling portion having a coupling hole into which the eccentric shaft portion is rotatably inserted, and a piston coupling portion provided at the other end thereof so as to be rotatably coupled into the piston, and wherein the coupling hole has an increasing diameter toward the body portion.

The coupling hole may be tapered such that the diameter thereof gradually increases toward the body portion.

A gap greater than a sliding tolerance may be provided between the coupling hole and the eccentric shaft portion toward the body portion.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a sectional view illustrating a coupling relationship between an eccentric shaft portion of a shaft and a connecting rod of a conventional hermetic compressor in a state in which the eccentric shaft portion is inclined;

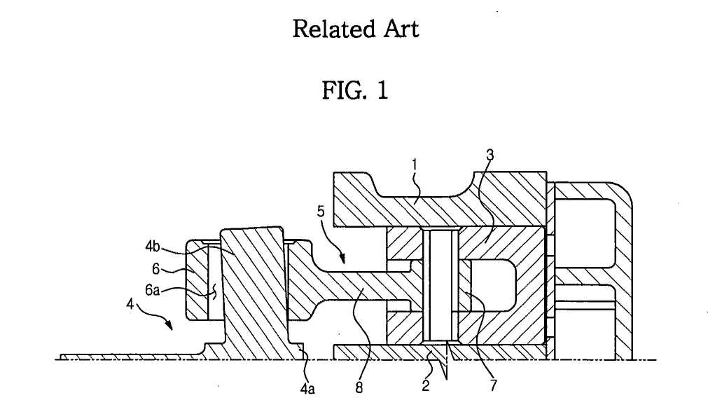

FIG. 2 is a sectional view illustrating the entire configuration of a hermetic compressor according to an exemplary embodiment of the present disclosure;

FIG. 3 is a partial perspective view of a connecting rod provided in the hermetic compressor according to the exemplary embodiment; and

FIG. 4 is a sectional view illustrating a coupling relationship between an eccentric shaft portion of a shaft and the connecting rod in the hermetic compressor according to the exemplary embodiment in a state in which the eccentric shaft portion is inclined.

### DETAILED DESCRIPTION

Reference will now be made in detail to a configuration of a hermetic compressor according to the exemplary embodiment of the present disclosure, examples of which are illustrated in the accompanying drawings, wherein like reference numerals refer to like elements throughout.

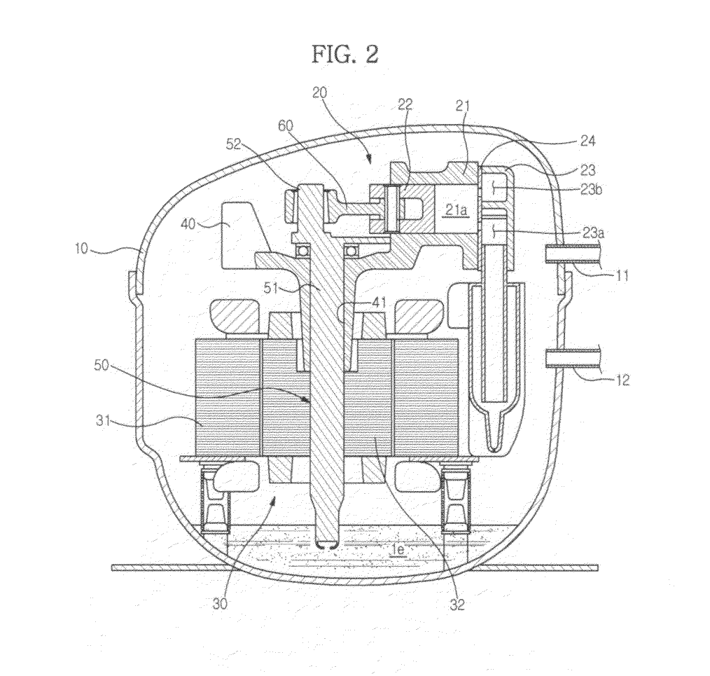

The hermetic compressor according to the present disclosure, as illustrated in FIG. 2, includes a hermetic container 10 defining an outer appearance of the compressor. A suction guide pipe 11 is connected to one side of the hermetic container 10 to guide a refrigerant having passed through an evaporator of a refrigeration cycle into the hermetic container 10. Also, a discharge guide pipe 12 is connected to the other side of the hermetic container 10 to guide the refrigerant compressed in the hermetic container 10 to a condenser of the refrigeration cycle.

The hermetic container 10 accommodates an oil reservoir 1e, a compression unit 20 to compress the refrigerant and a drive unit 30 to provide compression drive power. The compression unit 20 is installed using a frame 40.

The drive unit 30 is a motor and includes a stator 31 secured around a lower portion of the frame 40 and a rotor 32 rotatably inserted in the stator 31 to be rotated via electromagnetic interaction with the stator 31.

The compression unit 20 includes a cylinder 21 integrally formed with an upper portion of the frame 40, the cylinder 21 defining a compression chamber 21a therein, and a piston 22 rectilinearly reciprocating within the compression chamber 21a.

A cylinder head 23 is coupled to the cylinder 21 to hermetically seal the compression chamber 21a. The cylinder head 23 includes a refrigerant suction chamber 23a connected to the suction guide pipe 11 and a refrigerant discharge chamber 23b connected to the discharge guide pipe 12. A valve device 24 is provided between the cylinder head 23 and the cylinder 21 to control flow of the refrigerant from the refrigerant suction chamber 23a to the compression chamber 21a or from the compression chamber 21a to the refrigerant discharge chamber 23b.

A shaft 50 is installed in the center of the frame 40. The shaft 50 includes a body portion 51 and an eccentric shaft portion 52 provided at one end of the body portion 51. The body portion 51 rotatably penetrates a through-hole 41 perforated in the center of the frame 40 and is press-fitted into the rotor 32. Thus, the shaft 50 is rotated along with the rotor 32 during rotation of the rotor 32. In this case, the eccentric shaft portion 52 undergoes eccentric rotation. The eccentric shaft portion 52 longitudinally has a substantially constant outer diameter.

The eccentric shaft portion 52 and the piston 22 are connected to each other via a connecting rod 60, to transmit drive power of the drive unit 30 to the piston 22.

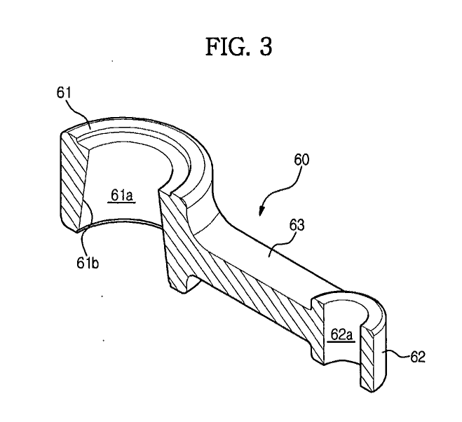

Referring to FIG. 3, one end of the connecting rod 60 forms a shaft coupling portion 61 rotatably coupled to the eccentric shaft portion 52, and the other end of the connecting rod 60 forms a piston coupling portion 62 rotatably coupled to the piston 22, a center connecting portion 63 of the connecting rod 60 connecting the shaft coupling portion 61 and the piston coupling portion 62 to each other.

The piston coupling portion 62 is inserted into a coupling space 22a defined in the piston 22 from the rear side of the piston 22. The piston coupling portion 62 has a first coupling hole 62a, and the piston 22 has a second coupling portion 22b corresponding to the first coupling hole 62a. A piston pin 27 is inserted through the corresponding first and second coupling holes 62a and 62b from the outside of the piston 22. In this case, the piston pin 27 is rotatably coupled into the first coupling hole 62a.

The shaft coupling portion 61 has a coupling hole 61a into which the eccentric shaft portion 62 is rotatably inserted.

Thus, if the shaft 50 is rotated along with the rotor 32 via driving of the drive unit 30, the eccentric shaft portion 52 eccentrically rotates, and the connecting rod 60 converts the eccentric rotational motion of the eccentric shaft portion 52 into rectilinear reciprocating motion of the piston 22.

As the piston 22 rectilinearly reciprocates within the compression chamber 21a, a pressure difference occurs between the interior and the exterior of the compression chamber 21a, causing the refrigerant introduced into the hermetic container 10 through the suction guide pipe 11 to be suctioned into the compression chamber 21a by way of the refrigerant suction chamber 23a. After the refrigerant is compressed in the compression chamber 21a, the compressed refrigerant is discharged from the compression chamber 21a to the refrigerant discharge chamber 23b and then, is discharged the outside of the hermetic container 10 through the discharge guide pipe 12.

The hermetic compressor according to the present embodiment is designed to continuously compress the refrigerant with high efficiency even if the shaft 50 is inclined when in use. To this end, the coupling hole 61a of the connecting rod 60 has an increasing diameter toward the body portion 51 of the shaft 50.

Specifically, since the shaft 50 is not completely rigid, although it is made of a rigid metallic material, the shaft 50 may be inclined by force applied from the piston 22 during compression of the refrigerant for the lifespan of the hermetic compressor.

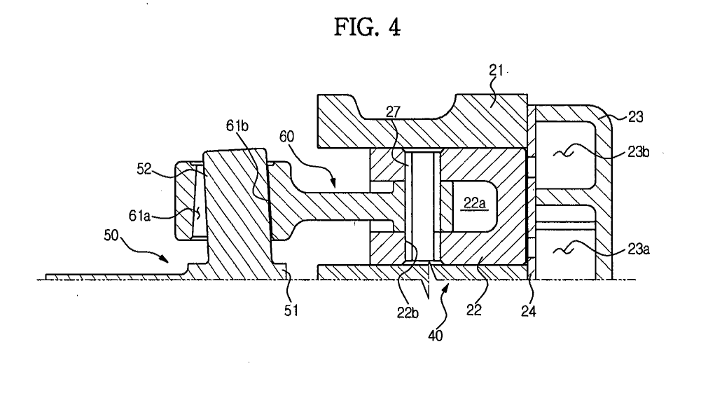

In this case, as illustrated in FIG. 4, the eccentric shaft portion 52 connected to the connecting rod 60 is inclined in an opposite direction of the piston 22. In the case of the connecting rod 60 in which the coupling hole 61a surrounding the eccentric shaft portion 52 has an increasing diameter toward the body portion 51 of the shaft 50, an inner surface of the coupling hole 61a may have a gradient close to that of an outer surface of the inclined eccentric shaft portion 52.

If the inner surface of the coupling hole 61a has a gradient close to that of the outer surface of the inclined eccentric shaft portion 52, the entire inner surface of the coupling hole 61a uniformly comes into contact with the outer surface of the eccentric shaft portion 52 in a longitudinal direction thereof, which may prevent concentrated abrasion of the shaft coupling portion 61 at a lower region of the coupling hole 61a due to friction between the eccentric shaft portion 52 and the coupling hole 61a. This may also prevent deformation of the connecting rod 60 due to the local abrasion of the shaft coupling portion 61, enabling efficient compression of the refrigerant.

That is, to allow the entire inner surface of the coupling hole 61a to more uniformly come into contact with the outer surface of the inclined eccentric shaft portion 52 in the longitudinal direction of the coupling hole 61a, the diameter of the coupling hole 61a may be tapered so as to gradually increase toward the body portion 51. In this case, the inner surface of the coupling hole 61a is a tapered surface 61b.

With regard to a boundary region between the eccentric shaft portion 52 and the body portion 51 of the shaft as designated by a dash-dot-dotted line in FIG. 4, the tapered surface 61b provides a gap greater than a sliding tolerance between the diameter of the coupling hole 61a and the outer diameter of the eccentric shaft portion 52. Thus, the hermetic compressor according to the present embodiment ensures easier assembly between the connecting rod 60 and the eccentric shaft portion 52.

More specifically, as described above, in the case where the cylinder 21 is integrally formed with the frame 40 so as not to be separated from the frame 40, to assemble the connecting rod 60 to the eccentric shaft portion 52, the piston coupling portion 62 of the connecting rod 60 is first rotatably inserted into the piston 22 and the piston 22 is inserted into the compression chamber 21a. Thereafter, the shaft coupling portion 61 of the connecting rod 60 is fitted on the eccentric shaft portion 52 such that the eccentric shaft portion 52 is inserted into the coupling hole 61a. With provision of the gap greater than the sliding tolerance between the diameter of the lower region of the coupling hole 61a and the outer diameter of the eccentric shaft portion 52 as described above, the eccentric shaft portion 52 has a greater gap with the coupling hole 61a as compared to that in the conventional hermetic compressor and thus, may be more easily coupled into the coupling hole 61a.

For reference, a sliding tolerance between the diameter of the coupling hole 61a and the outer diameter of the eccentric shaft portion 52 at the opposite side of the body portion 51 may have a sufficient value to restrict relative movement between the connecting rod 60 and the eccentric shaft portion 52 during compression of the refrigerant.

The tapered surface 61b of the coupling hole 61a may be formed simultaneously with formation of the connecting rod 60 using a mold to form the connecting rod 60, or may be formed by post-processing the inner surface of the coupling hole 61a of the completely formed connecting rod 60.

As is apparent from the above description, one or more embodiments include a hermetic compressor in which a coupling hole provided in a shaft coupling portion of a connecting rod has an increasing diameter toward a body portion of a shaft to ensure that an eccentric shaft portion of the shaft is easily inserted into the coupling hole.

Thus, even if the eccentric shaft portion is inclined in an opposite direction of a piston, an inner surface of the coupling hole has a gradient close to that of an outer surface of the inclined eccentric shaft portion, which allows the entire inner surface of the coupling hole to uniformly come into contact with the outer surface of the eccentric shaft portion in a longitudinal direction of the coupling hole.

As a result, the hermetic compressor according to the embodiment may prevent abrasion of the eccentric shaft portion at a lower region of the coupling hole of the shaft coupling portion due to friction between the eccentric shaft portion and the coupling hole even if the eccentric shaft portion is inclined in an opposite direction of the piston. This may prevent deformation of the connecting rod due to the local abrasion of the shaft coupling portion and ensure continuous efficient compression of a refrigerant.

In addition, when the coupling hole of the shaft coupling portion of the connecting rod has an increasing diameter toward the body portion of the shaft, a gap between the diameter of the coupling hole and the outer diameter of the eccentric shaft portion increases toward the body portion of the shaft, resulting in easier assembly between the connecting rod and the eccentric shaft portion.

Although the embodiment of the present disclosure has been shown and described, it would be appreciated by those skilled in the art that changes may be made in these embodiments without departing from the principles and spirit of the invention, the scope of which is defined in the claims and their equivalents.

What is claimed is:

1. A hermetic compressor comprising a drive unit to provide drive power for compression of a refrigerant, a shaft having a body portion coupled to the drive unit so as to be rotated by the drive unit and an eccentric shaft portion provided at one end of the body portion to perform eccentric rotational motion, and a piston connected to the eccentric shaft portion via a connecting rod to perform rectilinear reciprocating motion within a compression chamber,
wherein the connecting rod includes a shaft coupling portion provided at one end thereof for coupling with the shaft, the shaft coupling portion having a coupling hole into which the eccentric shaft portion is rotatably inserted, and a piston coupling portion provided at the other end thereof so as to be rotatably coupled into the piston, and
wherein the coupling hole has an increasing diameter toward the body portion.

2. The hermetic compressor according to claim 1, wherein the coupling hole is tapered such that the diameter thereof gradually increases toward the body portion.

3. The hermetic compressor according to claim 1, wherein a gap greater than a sliding tolerance is provided between the coupling hole and the eccentric shaft portion toward the body portion.

4. A connecting rod to connect a shaft to a piston, comprising:
a shaft coupling portion, the shaft coupling portion including a coupling hole into which a shaft portion is rotatably inserted, the coupling hole having an increasing diameter in an axial direction of the coupling hole;
a piston coupling portion;
a center connecting portion connecting the shaft coupling portion and the piston coupling portion to each other.
